(19) United States
(12) Patent Application Publication
(10) Pub. No.: US 2025/0151009 A1
(43) Pub. Date: May 8, 2025

(54) RESPONSE TIME BASED MANAGEMENT FOR SL POSITIONING RESOURCES

(71) Applicant: QUALCOMM Incorporated, San Diego, CA (US)

(72) Inventors: Srinivas YERRAMALLI, San Diego, CA (US); Mukesh KUMAR, Hyderabad, Telangana (IN); Alexandros MANOLAKOS, Athens, Attikí (GR)

(21) Appl. No.: 18/835,854

(22) PCT Filed: Mar. 17, 2023
(86) PCT No.: PCT/US23/15574

§ 371 Date: Aug. 5, 2024

(30) Foreign Application Priority Data
Apr. 29, 2022 (GR) 20220100354

(51) Int. Cl. H04W 64/00; H04L 67/141; H04L 67/303; H04W 92/18

(52) U.S. Cl. CPC H04W 64/00; H04L 67/141; H04L 67/303; H04W 92/18

(57) ABSTRACT

In some implementations, a first user equipment (UE) may send a first message comprising a quality of service (QoS) profile to a second UE. The QoS profile may include a response time requirement for providing positioning information within the positioning session. The first UE may receive a second message from the second UE, the second message comprising an indication of whether the second UE can meet the response time requirement. The first UE may determine resource pool parameters for the positioning session. The resource pool parameters may be based at least in part on the indication of whether the second UE can meet the response time requirement. The first UE may send a third message comprising the resource pool parameters to the second UE.

### RELATED APPLICATIONS

This application claims the benefit of Greek Application No. 20220100354, filed Apr. 29, 2022, entitled “RESPONSE TIME BASED MANAGEMENT FOR SL POSITIONING RESOURCES”, which is assigned to the assignee hereof, and incorporated herein in its entirety by reference.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

In a data communication network, various positioning techniques can be used to determine the position of a mobile device (referred to herein as a UE). Some of these positioning techniques may involve determining distance and/or angular information of RF signals received by one or more other UEs communicatively coupled with the data communication network. In a fifth generation (5G) wireless standard, referred to as New Radio (NR), direct communication between UEs (including the transmission of RF signals for positioning) may be referred to as sidelink (SL). A positioning session between UEs may be conducted to perform positioning measurements using SL RF signals, and UEs can coordinate such SL positioning sessions to ensure efficient use of bandwidth and other wireless resources.

### BRIEF SUMMARY

An example method of managing response time in a positioning session between a first user equipment (UE) and a second UE conducted via sidelink (SL), according to this disclosure, may comprise sending, from the first UE to the second UE, a first message comprising a quality of service (QoS) profile, wherein the QoS profile includes a response time requirement for providing positioning information within the positioning session. The method also may comprise receiving a second message at the first UE from the second UE, wherein the second message comprises an indication of whether the second UE can meet the response time requirement. The method also may comprise determining, with the first UE, resource pool parameters for the positioning session, wherein the resource pool parameters are based at least in part on the indication of whether the second UE can meet the response time requirement. The method also may comprise sending, from the first UE to the second UE, a third message comprising the resource pool parameters.

An example method of managing response time in a positioning session between a first user equipment (UE) and a second UE conducted via sidelink (SL), according to this disclosure, may comprise receiving, at the second UE from the first UE, a first message comprising a quality of service (QoS) profile, wherein the QoS profile includes a response time requirement for providing positioning information within the positioning session. The method also may comprise sending a second message from the second UE to the first UE, wherein the second message comprises an indication of whether the second UE can meet the response time requirement. The method also may comprise receiving, at the second UE from the first UE, a third message comprising resource pool parameters for the positioning session, wherein the resource pool parameters are based at least in part on the indication of whether the second UE can meet the response time requirement.

An example first user equipment UE for managing response time in a positioning session between the first UE and a second UE conducted via sidelink (SL), according to this disclosure, may comprise a transceiver, a memory, one or more processors communicatively coupled with the transceiver and the memory, wherein the one or more processors are configured to send, via the transceiver to the second UE, a first message comprising a quality of service (QoS) profile, wherein the QoS profile includes a response time requirement for providing positioning information within the positioning session. The one or more processors further may be configured to receive a second message via the transceiver from the second UE, wherein the second message comprises an indication of whether the second UE can meet the response time requirement. The one or more processors further may be configured to determine resource pool parameters for the positioning session, wherein the resource pool parameters are based at least in part on the indication of whether the second UE can meet the response time requirement. The one or more processors further may be configured to send, via the transceiver to the second UE, a third message comprising the resource pool parameters.

An example second user equipment (UE) for managing response time in a positioning session between a first UE and the second UE conducted via sidelink (SL), according to this disclosure, may comprise a transceiver, a memory, one or more processors communicatively coupled with the transceiver and the memory, wherein the one or more processors are configured to receive, via the transceiver from the first UE, a first message comprising a quality of service (QoS) profile, wherein the QoS profile includes a response time requirement for providing positioning information within the positioning session. The one or more processors further may be configured to send a second message via the transceiver to the first UE, wherein the second message comprises an indication of whether the second UE can meet the response time requirement. The one or more processors further may be configured to receive, via the transceiver from the first UE, a third message comprising resource pool parameters for the positioning session, wherein the resource pool parameters are based at least in part on the indication of whether the second UE can meet the response time requirement.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIGS. 3A-3C are simplified diagrams of scenarios in which sidelink positioning may be used to determine the position of a target user equipment (UE).

FIG. 4 is a call-flow diagram illustrating positioning session set up between a target UE and anchor UE, according to an embodiment.

FIG. 5 is a call-flow diagram illustrating a process by which parameters may be updated during a positioning session, according to an embodiment.

FIG. 6 is a call-flow diagram illustrating another process by which positioning session parameters may be updated during a positioning session, according to an embodiment.

FIG. 7 is a flow diagram of a method of managing response time in a positioning session between a first UE and a second UE conducted via SL, according to an embodiment.

FIG. 8 is a flow diagram of another method of managing response time in a positioning session between a first UE and a second UE conducted via SL, according to an embodiment.

FIG. 9 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Position determination of a UE may be based at least in part on measurements of signals transmitted and/or received by the UE via sidelink (SL). In some instances, it may be desirable to perform these measurements within a desired timeframe (e.g., “response time”) and/or with a desired accuracy. However, a UE may be unable to meet time (and/or accuracy) requirement given the available resources for performing these measurements in an SL positioning session. Embodiments herein for providing response time based management allow a UE (e.g., a target UE and/or anchor UE) to adjust certain parameters that may enable different resources to be used, which may in turn allow a UE to meet the time (and/or accuracy) requirement. Additional details regarding such embodiments are provided after a discussion of relevant technology.

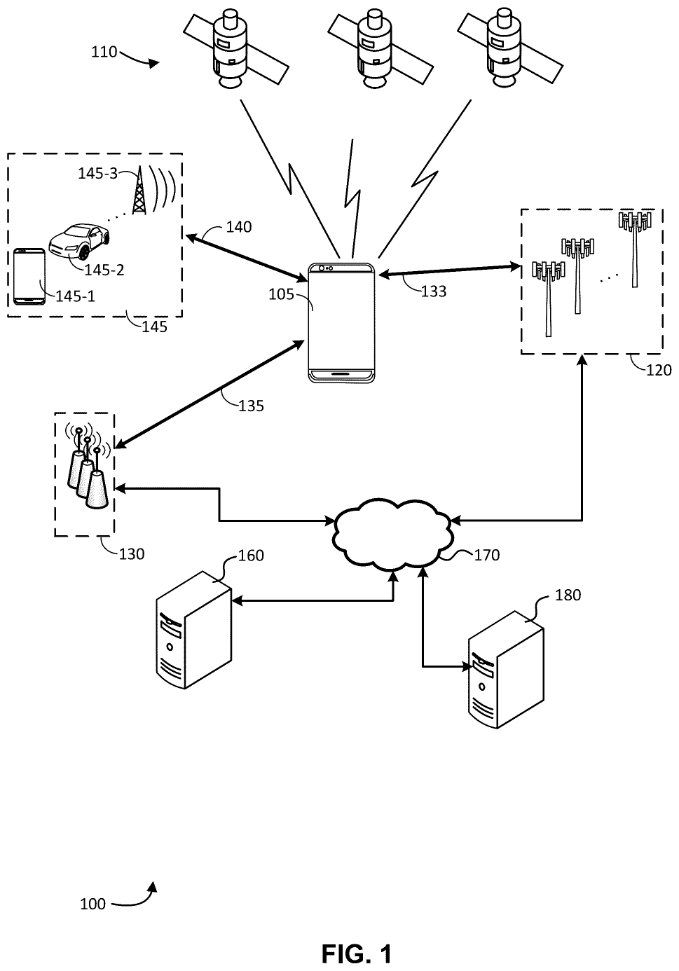

FIG. 1 is a simplified illustration of a positioning system 100 in which a mobile device 105, location server 160, and/or other components of the positioning system 100 can use the techniques provided herein for providing response time based management for SL positioning resources for positioning of the mobile device 105, according to an embodiment. The techniques described herein may be implemented by one or more components of the positioning system 100. The positioning system 100 can include: a mobile device 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding particular location estimation techniques are discussed hereafter.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. In a wireless cellular network (e.g., LTE or 5G), the mobile device 105 may be referred to as a user equipment (UE)

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the mobile device 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other mobile devices communicatively coupled with a cellular or other mobile network (e.g., network 170). When one or more other mobile devices 145 are used in the position determination of a particular mobile device 105, the mobile device 105 for which the position is to be determined may be referred to as the “target mobile device,” and each of the other mobile devices 145 used may be referred to as an “anchor mobile device.” (In a cellular/mobile broadband network, the terms “anchor UE” and “target UE” may be used.) For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another mobile device) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium, or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

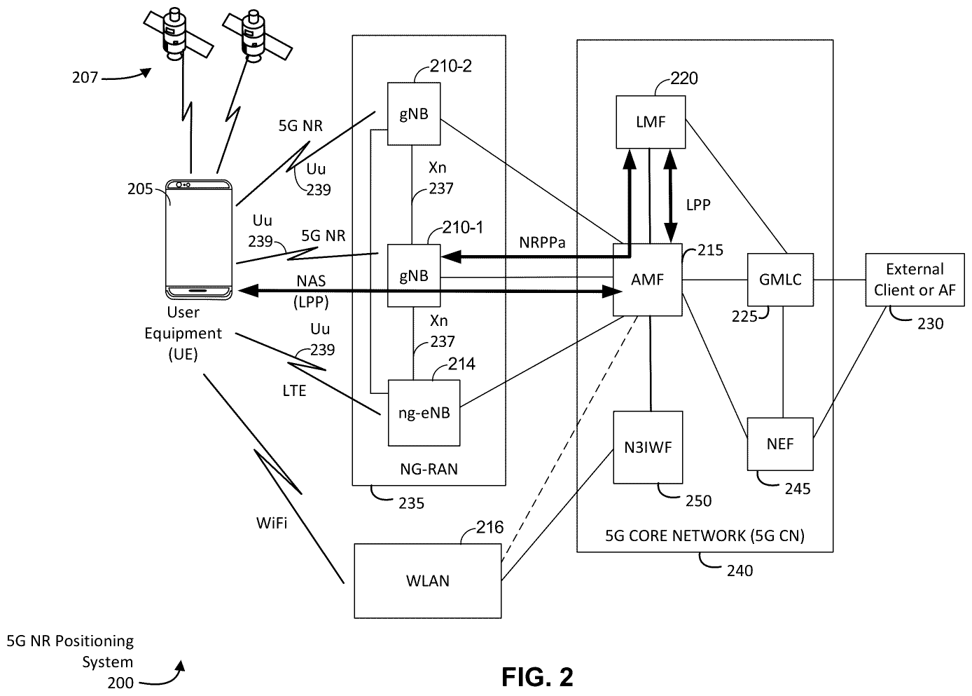

FIG. 2 shows a diagram of a 5G NR positioning system 200, illustrating an embodiment of a positioning system (which may correspond to at least a portion of a larger positioning system as described herein, such as the positioning system 100 of FIG. 1) implementing 5G NR. The 5G NR positioning system 200 may be configured to determine the location of a user equipment (UE) 205 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations described elsewhere herein, and the WLAN 216 may correspond with one or more access points described elsewhere herein. Optionally, the 5G NR positioning system 200 additionally may be configured to determine the location of a UE 205 by using an LMF 220 (which may correspond with a location server as described elsewhere herein) to implement the one or more positioning methods. Here, the 5G NR positioning system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 207. As previously indicated, satellites 207 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 207 may comprise NTN satellites that may be communicatively coupled with the LMF 220 and may operatively function as a TRP (or TP) in the NG-RAN 235. As such, satellites 207 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 207, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like one or more RATs as described elsewhere herein) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to an external client as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations as described elsewhere herein and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., access points, as described elsewhere herein). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

In a 5G NR positioning system 200, positioning methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 207), WLAN, etc.

With a UE-based position method, UE 205 may obtain location measurements (e.g., which may be the same as or similar to location measurements for a UE assisted position method) and may further compute a location of UE 205 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, that is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

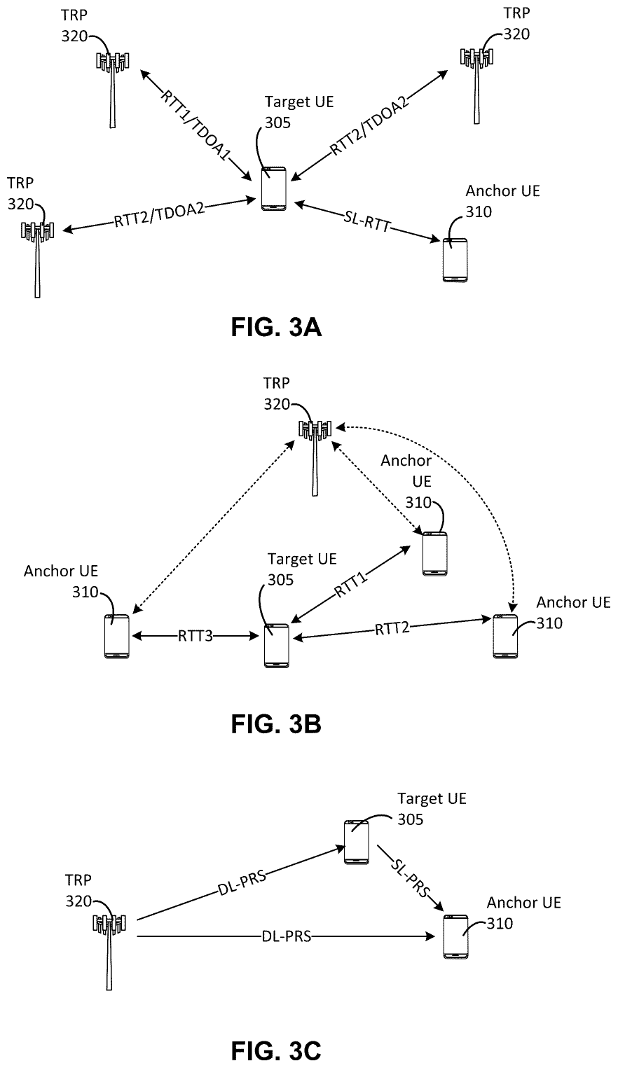

FIGS. 3A-3C are simplified diagrams of scenarios in which sidelink positioning may be used to determine the position of a target UE 305, according to some embodiments. One or more anchor UEs 310 may be used to send and/or receive reference signals via sidelink. As illustrated, positioning may be further determined using one or more base stations 320 (a Uu interface). It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three base stations 320. In this configuration, the target UE 305 may be in coverage range for DL and/or UL signals via Uu connections with the base stations 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the sidelink connection between the target UE 305 and anchor UE 310.

The diagram of FIG. 3B illustrates a configuration in which the positioning of a target UE 305 may sidelink only (SL-only) positioning/ranging. In this configuration, the target UE 305 may perform RTT measurements via sidelink connections between a plurality of anchor UEs 310. In this example, the target UE 305 may not be in UL coverage of the base station 320, and therefore each anchor UE 310 may report RTT measurement information to the network of via a Uu connection between each anchor UE 310 and the base station 320. (In cases in which a UE relays information between a remote UE and a base station, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IoT devices, etc.). In other scenarios in which the target UE 305 is within UL coverage of the base station 320, the target UE 305 may report RTT measurements directly to the base station 320. In some embodiments, no base station 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the base station 320, and the target UE 305 sending a reference signal (SL-PRS) to the anchor UE 310. The positioning of the target UE can be determined based on known positions of the base station 320 and anchor UE 310 and a time difference between a time at which the anchor UE 310 receiving the reference signal from the base station 320 and a time at which the anchor UE 310 receives the reference signal from the target UE 305.

As previously discussed, the use of sidelink positioning (e.g., SL-only or Uu/SL positioning, as illustrated in FIGS. 3A-3C) may utilize a Resource Pool for Positioning (RP-P). RP-P may be conveyed to UEs via a sidelink configuration (e.g., using techniques described hereafter), and may designate particular resource pools for sidelink reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via sidelink for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset) Resource pools may comprise, for example, Tx resource pools for “Mode 1” sidelink positioning in which sidelink positioning is performed using one or more network-connected UEs, in which case network-based resource allocation may be received by a network-connected UE via a Uu interface with a base station (e.g., via Downlink Control Information (DCI) or Radio Resource Control (RRC)). Tx resource pools for “Mode 2” sidelink positioning in which autonomous resource selection is performed by UEs without network-based resource allocation. Resource pools may further comprise Rx resource pools, which may be used in either Mode 1 or Mode 2 sidelink positioning. Each RP-P configuration may be relayed via a physical sidelink control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR).

According to some embodiments, exceptional RP-P can be designated and used in circumstances in which it may not be desirable or possible to perform sidelink positioning via the available resource pools of non-exceptional RP-P for sidelink. Such exceptional cases may include situations similar to those that trigger the use of exceptional resource pools for communication, such as situations in which there may be physical layer problems, before the UE finishes and initiated connection, or during a handover of the UE. As with non-exceptional RP-P for sidelink, exceptional RP-P for sidelink may be configured or preconfigured, and may be allocated by the network or autonomously selected (e.g., used in Mode 1 or Mode 2 sidelink positioning). Further, according to some embodiments, exceptional RP-P may be preconfigured, preloaded, and/or hardcoded into UEs for different geographic regions or areas. Different countries, for example, may designate particular resources for exceptional RP-P in cases of public safety. Exceptional RP-P may be configured via dedicated signaling (e.g., PC5) and/or configured via System Information Block (SIB) via a Uu interface. In some embodiments, the exceptional RP-P may be broadcasted during the positioning session setup phase or discovery phase of a UE. Additionally or alternatively, exceptional RP-P may be assigned or allocated using resource reservation techniques.

Allocating SL-PRS for use during an SL positioning session can take two different approaches. A first approach comprises a semi-static configuration that uses pre-defined resources in a dedicated positioning resource pool (e.g., RP-P). A second approach comprises a dynamic configuration in which resource determination may be contention based. Quality of service (QoS) parameters for positioning, such as response time (e.g., a specified delay budget for providing a position estimate) can be considered when determining resource periodicity for a semi-static configuration. For contention-based resource determination, current procedures provide little to help ensure that positioning session is completed, for example, in the specified delay budget.

Embodiments address these and other issues by providing mechanisms that a target UE and anchor UE may utilize to help ensure the anchor UE can meet response time and/or other QoS parameters for a positioning session between the anchor UE and the target UE. These mechanisms include the use of a QoS profile and/or parameter adjustments by the target UE and/or anchor UE. These mechanisms may be utilized during a positioning session setup between the target UE and anchor UE, and/or may be utilized during the positioning session itself. Additional details follow hereafter.

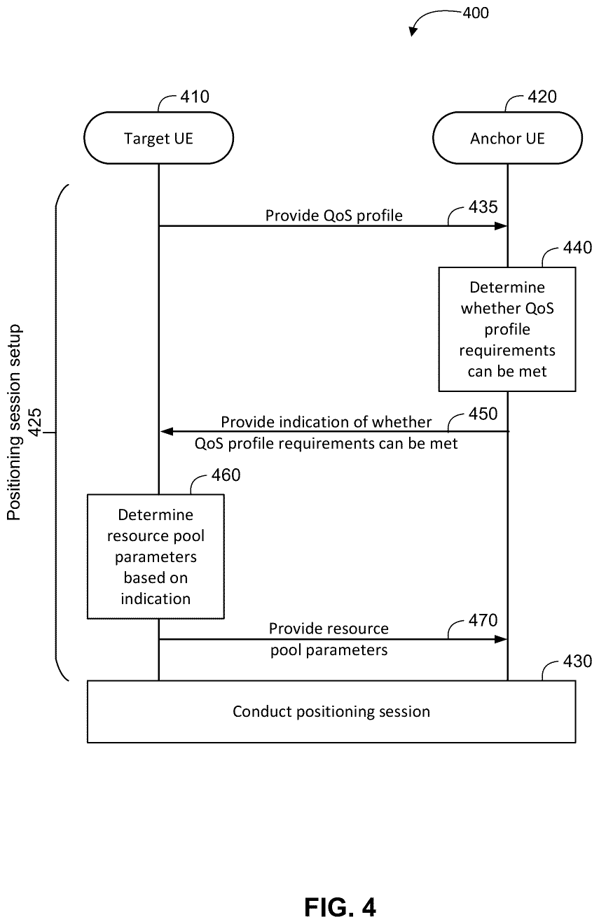

FIG. 4 is a call-flow diagram illustrating a process 400 of positioning session set up between a target UE 410 and anchor UE 420, according to an embodiment. (The target UE 410 and anchor UE 420 may respectively correspond with target and anchor UEs described elsewhere herein, including FIGS. 3A-3C, for example. Either or both target UE 410 and anchor UE 420 also may generally correspond with user equipment 205 of FIG. 2 and/or mobile device 105 of FIG. 1.) Here, the target UE 410 and anchor UE 420 may perform a series of actions during a positioning session setup 425, in preparation for conducting a SL positioning session at block 430.

Here, the process 400 may be initiated by the target UE 410, and may include other actions not explicitly indicated in FIG. 4, such as establishing an SL communication link, capability exchange, and/or other such common positioning set up operations. The target UE 410 may initiate the process 400 in response to a request at the target UE 410 (e.g., by an application executed by the target UE 410), another device, or a network, for the position of the target UE 410. In some circumstances, the target UE 410 may initiate the positioning session with a plurality of anchor UEs, in which case the process 400 may be replicated between the target UE 410 and each of the anchor UEs.

During the positioning session setup 425, the target UE 410 may provide the anchor UE 420 with a QoS profile, as indicated at arrow 435. The QoS profile may comprise one or more QoS parameters for the positioning session, which may be based on positioning requirements for the target UE 410. Generally speaking, the QoS profile may provide parameters relating to timing and/or accuracy requirements for the positioning session between the target UE 410 and anchor UE 420.

For example, according to an embodiment, the QoS profile may specify a response time requirement, a horizontal accuracy requirement, a vertical accuracy requirement, a vertical coordinate request indicator, a velocity request indicator, or a combination thereof. In this example, the response time requirement comprises a time within which the anchor UE 420 is to provide positioning information (e.g., a final fix, although a first/early fix may be specified as well). The horizontal accuracy requirement and vertical accuracy requirement may comprise maximum respective horizontal and vertical error for positioning information. Vertical coordinate request indicator and velocity request indicator may comprise Boolean values respectively indicating whether a vertical coordinate or velocity information is to be included in the positioning information provided by the anchor UE 420. In some embodiments, the response time requirement may need to be met even if one or more of the accuracy requirements cannot be met.

At block 440, the anchor UE 420 can then determine whether it can meet the QoS profile requirements. With respect to the response time requirement, for example, the anchor UE 420 may be engaged in communication, other positioning sessions, and/or other commitments/operations that may limit the anchor UE's capacity for providing positioning information within the response time. As such, the anchor UE 420 may determine whether the QoS profile requirements can be met based at least in part on the anchor UE's capabilities (processing, bandwidth, etc.) and other scheduled operations.

In response to the determination made at block 440, the anchor UE 420 can then provide an indication of whether the QoS profile requirements can be met, as indicated at arrow 450. Depending on desired functionality, the anchor UE 420 can provide an indication with respect to each QoS profile requirement (e.g., whether each one can be met), or may provide an indication of whether all of them can be met or not.

As indicated at block 460, the target UE 410 then determines resource pool parameters for the positioning session based on the indication provided by the anchor UE 420, which are then sent to the anchor UE 420, as indicated at arrow 470. These resource pool parameters can include, for example, the use of resources in a dedicated positioning resource pool (e.g., RP-P) and/or a contention based pool, a sensing-window-positioning duration, a type of sensing, or a combination thereof. The type of sensing may comprise full sensing, partial sensing, or random selection according to some embodiments, the target UE 410 may further indicate some parameters to other anchor UEs participating in the positioning session. These parameters may include, for example, resource selection window/sensing parameters.

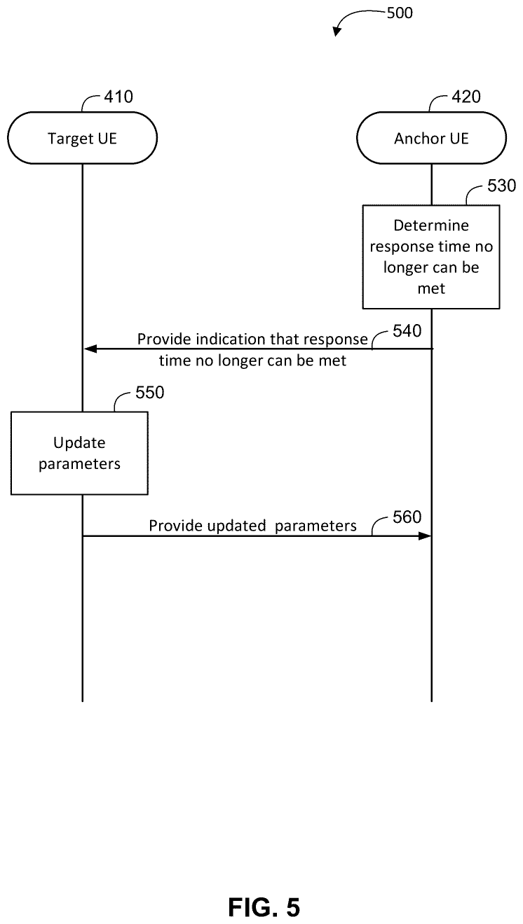

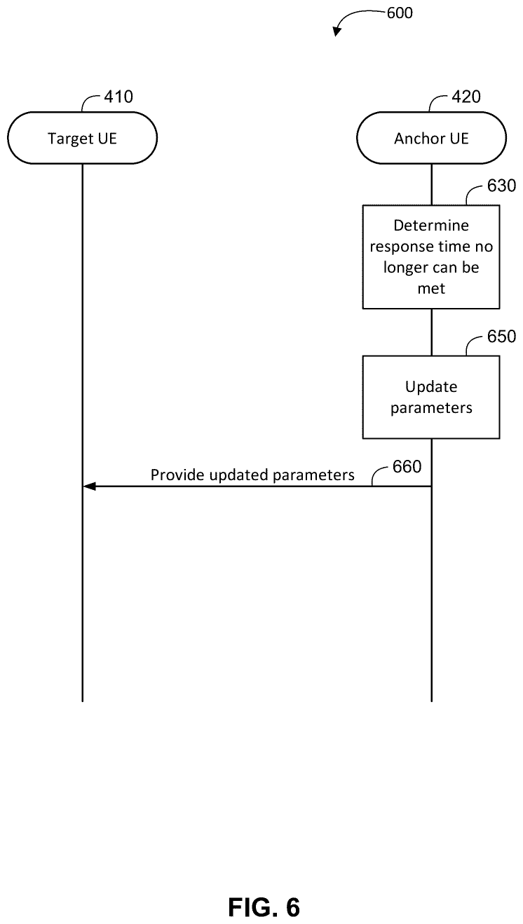

According to some embodiments, positioning session parameters (e.g., resource pool parameters) can be determined based on whether the anchor UE 420 cannot meet one or more of the QoS profile requirements. Additionally or alternatively, positioning session parameters may be adjusted during the positioning session if an anchor UE 420 determines it is no longer capable of meeting one or more of the QoS profile requirements. More specifically, the determination of the resource pool parameters at block 460 may be based on the indication provided at arrow 450 during the positioning session setup 425, or adjustments of the resource pool parameters may be made by the anchor UE 420 or target UE 410 during the positioning session, as shown in FIGS. 5 and 6, which are discussed in more detail hereafter.

FIG. 5 is a call-flow diagram illustrating a process 500 by which parameters may be updated during a positioning session, according to an embodiment. Here, the target UE 410 and anchor UE 420 may have established initial parameters in the manner illustrated in the process 400 of FIG. 4, for example, and may be engaged in a positioning session. During the positioning session, the anchor UE 420 may reevaluate whether it is able to meet a response time provided by the target UE 410 (e.g., as part of the QoS profile). This reevaluation may occur periodically and/or may be based on certain triggers (e.g., if there has been a change in available resources due to other data/positioning commitments). At block 530, the anchor may determine (e.g., as a result of a reevaluation) that the response time longer can be met.

As a result, the anchor UE 420 can then provide an indication that the response time can longer be met to the target UE 410, as indicated at arrow 540. According to some embodiments, this indication may include an indication of why the response time can longer be met, if available (e.g., full sensing is taking too long, contention-based resources are unavailable, etc.) and/or an indication of updated resources that may be used.

After receiving the indication that the response time can longer be met, the target UE can then update parameters for the positioning session, as indicated at block 550, then provide the updated parameters to the anchor UE 420, as indicated at arrow 560. The updated parameters may be based, at least in part, on information provided by the anchor UE (if any), such as updated resource information, available bandwidth, etc. For operation in an unlicensed spectrum, resource availability provided to the target UE 410 by the anchor UE 420 may also include channel access success. Updated parameters may include, for example, a higher priority level for positioning session, a different resource selection strategy, a different physical (PHY) layer parameter configuration, or combination thereof.

A different resource selection strategy may comprise, for example, a change in a sensing type. For instance, full sensing may be originally specified for the positioning session (e.g., as part of resource pool parameters provided at arrow 470 of FIG. 4), but A UE may choose partial or random selection sensing (which do not take as long as full sensing) based on a response time requirement and a time elapsed (e.g., if full sensing is no longer feasible in the remaining amount of time before the response time elapses).

A different PHY layer parameter configuration may comprise any of a variety of changes to PHY layer transmissions for the positioning session. For example, a transmission having a lower repetition factor (e.g., of reference signals) and/or a smaller bandwidth may be selected to help meet the response time constraint. For example, the anchor may not be able to secure a 100 MHz channel for positioning, but may be able to secure a 60 MHz channel. Similarly, the anchor UE may not be able to secure four repetitions of SL PRS, but may be able to secure two repetitions. Other PHY layer transmission parameters may include a number of symbols in a Orthogonal frequency division multiplexing (OFDM) communication regime used to transmit a reference signal resource, a number of reference signal resources in a resource set, or the like. Ultimately, according to the process 500 in FIG. 5, parameters of and SL positioning session between a target UE 410 and anchor UE 420 may be initially figured and/or subsequently adjusted (e.g., during the positioning session) to help ensure the anchor UE 420 is able to meet the response time requirement originally provided by the target UE 410 (e.g., as part of the QoS profile).

FIG. 6 is a call-flow diagram illustrating another process 600 by which positioning session parameters may be updated during a positioning session, according to an embodiment. Similar to the process 500 of FIG. 5, the target UE 410 and anchor UE 420 may have established initial parameters in the manner illustrated in the process 400 of FIG. 4, for example, and may be engaged in a positioning session. In contrast to the process 500 of FIG. 5, however, the anchor UE 420 can update the positioning session parameters. That is, after determining the response time can no longer be met (as shown in block 630, similar to block 530 of FIG. 5), the anchor UE 420 can update the positioning parameters, as shown at block 650. The anchor UE 420 can then provide updated parameters to the target UE 410, as indicated at arrow 660.

Other aspects may be similar to the process 500 of FIG. 5. For example, the anchor UE 420 may reevaluate whether it is able to meet a response time provided by the target UE 410 (e.g., periodically, based on certain triggers, etc.) at one or more times during the positioning session. The anchor UE 420 can then update parameters for the positioning session, using the same or similar considerations as described previously with respect to the process 500 of FIG. 5. This can include updating priority level, resource selection strategy, PHY layer parameter configuration, or a combination thereof. For changes to PHY layer transmission parameters, they may be indicated to the target UE 410 via a PSCCH or physical sidelink shared channel (PSSCH) message.

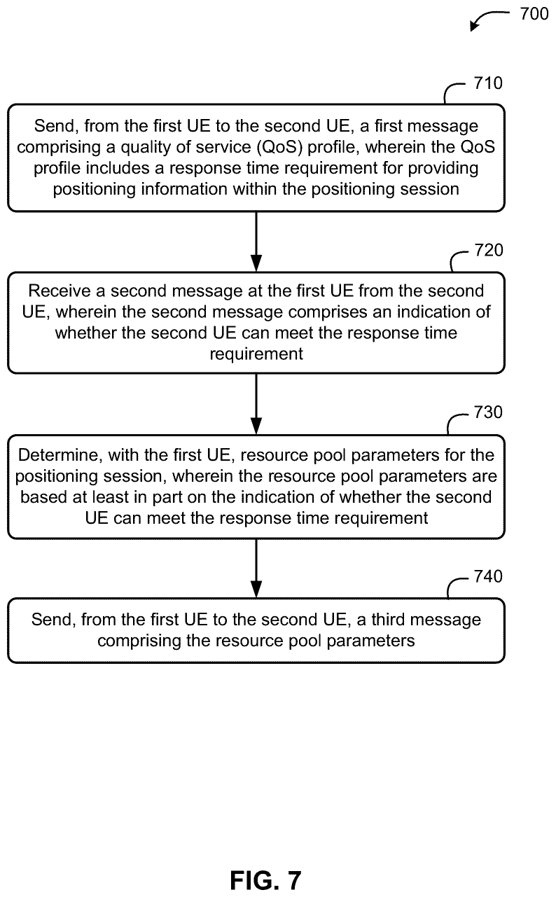

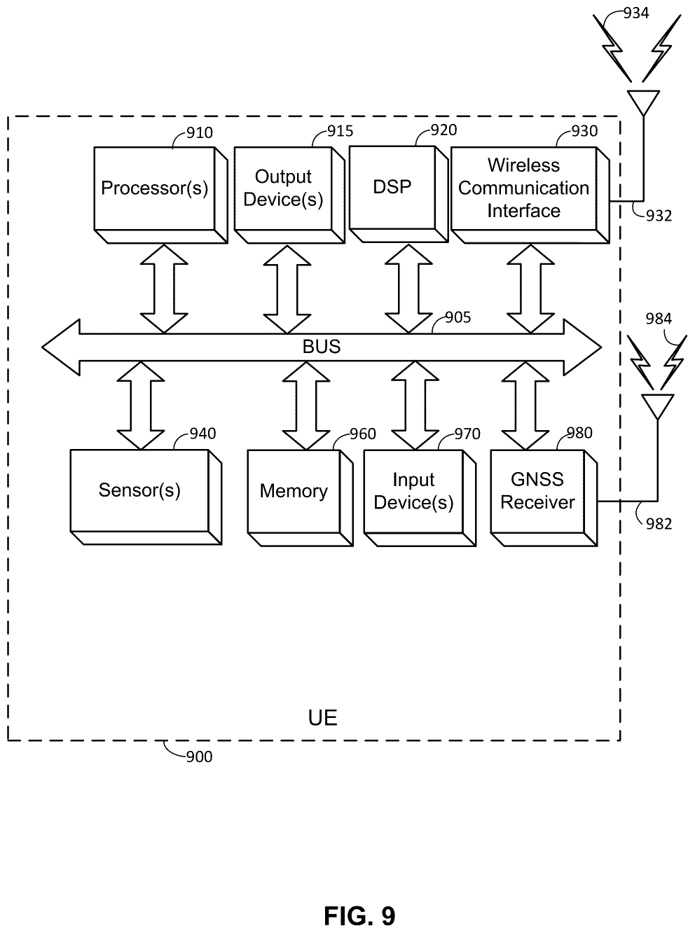

FIG. 7 is a flow diagram of a method 700 of managing response time in a positioning session between a first UE and a second UE conducted via SL, according to an embodiment. Here, the first UE may correspond with a target UE and the second UE may correspond with a anchor UE, as described in FIGS. 4-6. The functionality of the method 700 may reflect aspects of the processes illustrated in FIGS. 4 and 5. Means for performing the functionality illustrated in one or more of the blocks shown in FIG. 7 may be performed by hardware and/or software components of a UE. Example components of a UE are illustrated in FIG. 9, which is described in more detail below.

At block 710, the functionality comprises sending, from the first UE to the second UE, a first message comprising a quality of service (QoS) profile, wherein the QoS profile includes a response time requirement for providing positioning information within the positioning session. As previously indicated, the response time requirement may comprise a maximum delay (which may be on the order of hundreds of milliseconds to several seconds, or greater, for example) for providing the positioning information, such as a final position fix. As indicated in the previously-described embodiments, the QoS profile may comprise additional requirements. This may include, for example, a horizontal accuracy requirement, a vertical accuracy requirement, a vertical coordinate request indicator, a velocity request indicator, or a combination thereof.

Means for performing functionality at block 710 may comprise bus 905, processor(s) 910, wireless communication interface 930, sensors 940, memory 960, GNSS receiver 980, and/or other components of a UE, such as those as illustrated in FIG. 9 and described hereafter.

At block 720, the functionality comprises receiving a second message at the first UE from the second UE, wherein the second message comprises an indication of whether the second UE can meet the response time requirement. As noted in the embodiments described previously, the receipt of this indication can occur in a positioning session set up and/or during the positioning session itself. As such, this indication can inform the first UE (e.g., the target UE) regarding what resource pool parameters to use initially for the positioning session and/or how resource pool parameters should be adjusted during the positioning session. As previously noted, items like priority, sensing type, resource pool type, and so forth may be selected based on whether the second UE (e.g., the anchor UE) is capable of meeting the response time requirement in the QoS profile.

Means for performing functionality at block 720 may comprise bus 905, processor(s) 910, wireless communication interface 930, sensors 940, memory 960, GNSS receiver 980, and/or other components of a UE, such as those as illustrated in FIG. 9 and described hereafter.

At block 730, the functionality comprises, determining, with the first UE, resource pool parameters for the positioning session, wherein the resource pool parameters are based at least in part on the indication of whether the second UE can meet the response time requirement. As noted in the embodiments above, the indication may be accompanied with other information, such as available bandwidth and/or other resources. Further, as also previously noted, the resource pool parameters may comprise a variety of parameters for conducting the positioning session. This can include, for example, a dedicated positioning resource pool, contention based pool, a sensing-window-positioning duration, a type of sensing, or a combination thereof. According to some embodiments, the type of sensing may comprise full sensing, partial sensing, or random selection sensing.

According to some embodiments, the indication of whether the second UE can meet the response time requirement may comprise an indication the second UE cannot meet the response time requirement. In such embodiments, the method 700 may further comprise, responsive to the indication the second UE cannot meet the response time requirement, determining, with the first UE, a priority level for the positioning session, wherein the priority level is included in the resource pool parameters for the positioning session. Additionally or alternatively the method 700 may comprise, responsive to the indication the second UE cannot meet the response time requirement, determining, with the first UE, random selection sensing as a type of sensing for the positioning session, wherein the random selection sensing is included in the resource pool parameters for the positioning session. Additionally or alternatively, the method may further comprise, responsive to the indication the second UE cannot meet the response time requirement, determining, with the first UE, a physical (PHY) layer transmission parameter, wherein the PHY layer transmission parameter is included in the resource pool parameters for the positioning session.

Means for performing functionality at block 730 may comprise bus 905, processor(s) 910, wireless communication interface 930, sensors 940, memory 960, GNSS receiver 980, and/or other components of a UE, such as those as illustrated in FIG. 9 and described hereafter.

At block 740, the functionality comprises, sending, from the first UE to the second UE, a third message comprising the resource pool parameters. This can inform the second UE (e.g., the anchor UE) regarding how the positioning session should be conducted. Again, parameters may be set prior to and/or during the positioning session. As such, according to some embodiments of the method 700, the second message may be received and the third message may be sent prior to the positioning session, or the second may be received and the third message may be sent during to the positioning session. Initially or alternatively, according to some embodiments, the positioning session May use a resource pool carrying SL-PRS, SL PSCCH, or both.

Means for performing functionality at block 740 may comprise bus 905, processor(s) 910, wireless communication interface 930, sensors 940, memory 960, GNSS receiver 980, and/or other components of a UE, such as those as illustrated in FIG. 9 and described hereafter.

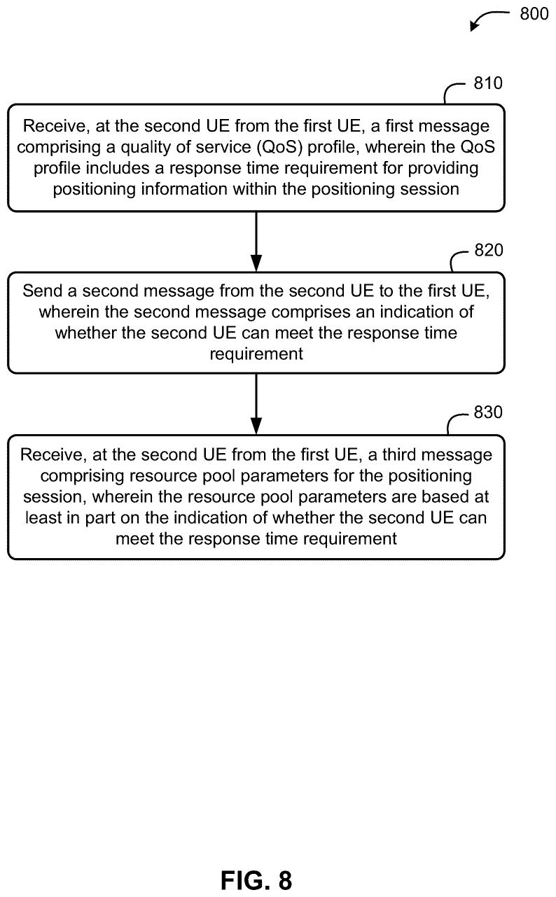

FIG. 8 is a flow diagram of another method 800 of managing response time in a positioning session between a first UE and a second UE conducted via SL, according to an embodiment. Again, the first UE may correspond with a target UE and the second UE may correspond with an anchor UE, as described in FIGS. 4-6. The functionality of the method 800 may reflect aspects of the processes illustrated in FIGS. 4 and 6. Means for performing the functionality illustrated in one or more of the blocks shown in FIG. 8 may be performed by hardware and/or software components of a UE. Example components of a UE are illustrated in FIG. 9, which is described in more detail below.

At block 810, the functionality comprises receiving at the second UE from the first UE, a first message comprising a quality of service (QoS) profile, wherein the QoS profile includes a response time requirement for providing positioning information within the positioning session. Again, the time requirement may comprise a maximum duration for providing positioning information, such as a final fix. In some embodiments, the QoS profile may further comprise a horizontal accuracy requirement, a vertical accuracy requirement, a vertical coordinate request indicator, a velocity request indicator, or a combination thereof.

Means for performing functionality at block 810 may comprise bus 905, processor(s) 910, wireless communication interface 930, sensors 940, memory 960, GNSS receiver 980, and/or other components of a UE, such as those as illustrated in FIG. 9 and described hereafter.

At block 820, the functionality comprises sending a second message from the second UE to the first UE, wherein the second message comprises an indication of whether the second UE can meet the response time requirement. This indication may be based on a determination of whether the second UE can meet the response time requirement based on factors such as current commitments to other operations/processes (e.g., positioning and/or data), processing capabilities, communication capabilities, etc. Accordingly, according to some embodiments, the method 800 may further comprise determining, with the second UE, that the second UE cannot meet the response time requirement.

As noted in FIG. 6, an anchor UE (e.g., the second UE) may be capable of autonomously choosing to perform certain operations and/or update certain parameters to be able to meet the response time requirement. According to some embodiments, for example, the method 800 may further comprise, responsive to determining the second UE cannot meet the response time requirement, determining, with the second UE, a priority level for the positioning session; determining, with the second UE, random selection sensing as a type of sensing for the positioning session; determining, with the second UE, a physical (PHY) layer transmission parameter; or a combination thereof.

Means for performing functionality at block 820 may comprise bus 905, processor(s) 910, wireless communication interface 930, sensors 940, memory 960, GNSS receiver 980, and/or other components of a UE, such as those as illustrated in FIG. 9 and described hereafter.

At block 830, the functionality comprises, receiving, at the second UE from the first UE, a third message comprising resource pool parameters for the positioning session, wherein the resource pool parameters are based at least in part on the indication of whether the second UE can meet the response time requirement. As previously noted, the resource pool parameters may comprise a dedicated positioning resource pool, contention based pool, a sensing-window-positioning duration, a type of sensing, or a combination thereof. The type of sensing may comprise full sensing, partial sensing, or random selection sensing. Again, the method 800 may occur prior to or during a positioning session. As such, according to some embodiments, the second message may be sent and the third message may be received to the positioning session; or the second message may be sent and the third message may be received during to the positioning session. Additionally or alternatively, positioning session May use a resource pool carrying SL positioning reference signal (SL-PRS), SL physical sidelink control channel (PSCCH), or both.

Means for performing functionality at block 830 may comprise bus 905, processor(s) 910, wireless communication interface 930, sensors 940, memory 960, GNSS receiver 980, and/or other components of a UE, such as those as illustrated in FIG. 9 and described hereafter.

FIG. 9 is a block diagram of an embodiment of a UE 900, which can be utilized as described herein above (e.g., in association with the previously-described figures). It should be noted that FIG. 9 is meant only to provide a generalized illustration of various components, any or all of which may be utilized as appropriate. Furthermore, the functionality of the UE discussed herein may be executed by one or more of the hardware and/or software components illustrated in FIG. 9.

The UE 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The UE 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 900 to communicate with other devices as described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 900 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 910 or DSP 920.

The UE 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 900 (and/or processor(s) 910 or DSP 920 within UE 900). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of managing response time in a positioning session between a first user equipment (UE) and a second UE conducted via sidelink (SL), the method comprising: sending, from the first UE to the second UE, a first message comprising a quality of service (QoS) profile, wherein the QoS profile includes a response time requirement for providing positioning information within the positioning session; receiving a second message at the first UE from the second UE, wherein the second message comprises an indication of whether the second UE can meet the response time requirement; determining, with the first UE, resource pool parameters for the positioning session, wherein the resource pool parameters are based at least in part on the indication of whether the second UE can meet the response time requirement; and sending, from the first UE to the second UE, a third message comprising the resource pool parameters.
Clause 2. The method of clause 1, wherein the resource pool parameters comprise: a dedicated positioning resource pool, a contention based pool, a sensing-window-positioning duration, a type of sensing, or a combination thereof.
Clause 3. The method of clause 2 wherein the type of sensing comprises: full sensing, partial sensing, or random selection sensing.
Clause 4. The method of any one of clauses 1-3 wherein the QoS profile further comprises: a horizontal accuracy requirement, a vertical accuracy requirement, a vertical coordinate request indicator, a velocity request indicator, or a combination thereof.
Clause 5. The method of any one of clauses 1-4 wherein the indication of whether the second UE can meet the response time requirement comprises an indication the second UE cannot meet the response time requirement.
Clause 6. The method of clause 5 further comprising, responsive to the indication the second UE cannot meet the response time requirement, determining, with the first UE, a priority level for the positioning session, wherein the priority level is included in the resource pool parameters for the positioning session.
Clause 7. The method of any one of clauses 5-6 further comprising, responsive to the indication the second UE cannot meet the response time requirement, determining, with the first UE, random selection sensing as a type of sensing for the positioning session, wherein the random selection sensing is included in the resource pool parameters for the positioning session.
Clause 8. The method of any one of clauses 5-7 further comprising, responsive to the indication the second UE cannot meet the response time requirement, determining, with the first UE, a physical (PHY) layer transmission parameter, wherein the PHY layer transmission parameter is included in the resource pool parameters for the positioning session.
Clause 9. The method of any one of clauses 1-8 wherein the second message is received and the third message is sent prior to the positioning session; or the second message is received and the third message is sent during to the positioning session.
Clause 10. The method of any one of clauses 1-9 wherein the positioning session uses a resource pool carrying SL positioning reference signal (SL-PRS), SL physical sidelink control channel (PSCCH), or both.
Clause 11. A method of managing response time in a positioning session between a first user equipment (UE) and a second UE conducted via sidelink (SL), the method comprising: receiving, at the second UE from the first UE, a first message comprising a quality of service (QoS) profile, wherein the QoS profile includes a response time requirement for providing positioning information within the positioning session; sending a second message from the second UE to the first UE, wherein the second message comprises an indication of whether the second UE can meet the response time requirement; and receiving, at the second UE from the first UE, a third message comprising resource pool parameters for the positioning session, wherein the resource pool parameters are based at least in part on the indication of whether the second UE can meet the response time requirement.
Clause 12. The method of clause 11, wherein the resource pool parameters comprise: a dedicated positioning resource pool, a contention based pool, a sensing-window-positioning duration, a type of sensing, or a combination thereof.
Clause 13. The method of clause 12 wherein the type of sensing comprises: full sensing, partial sensing, or random selection sensing.
Clause 14. The method of any one of clauses 11-13 wherein the QoS profile further comprises: a horizontal accuracy requirement, a vertical accuracy requirement, a vertical coordinate request indicator, a velocity request indicator, or a combination thereof.
Clause 15. The method of any one of clauses 11-14 further comprising determining, with the second UE, that the second UE cannot meet the response time requirement.
Clause 16. The method of clause 15 further comprising, responsive to determining the second UE cannot meet the response time requirement, determining, with the second UE, a priority level for the positioning session.
Clause 17. The method of any one of clauses 15-16 further comprising, responsive to determining the second UE cannot meet the response time requirement, determining, with the second UE, random selection sensing as a type of sensing for the positioning session.
Clause 18. The method of any one of clauses 15-17 further comprising, responsive to determining the second UE cannot meet the response time requirement, determining, with the second UE, a physical (PHY) layer transmission parameter.
Clause 19. The method of any one of clauses 11-18 wherein the second message is sent and the third message is received to the positioning session; or the second message is sent and the third message is received during to the positioning session.
Clause 20. The method of any one of clauses 11-19 wherein the positioning session uses a resource pool carrying SL positioning reference signal (SL-PRS), SL physical sidelink control channel (PSCCH), or both.
Clause 21. A first user equipment UE for managing response time in a positioning session between the first UE and a second UE conducted via sidelink (SL), the first UE comprising: a transceiver; a memory; and one or more processors communicatively coupled with the transceiver and the memory, wherein the one or more processors are configured to: send, via the transceiver to the second UE, a first message comprising a quality of service (QoS) profile, wherein the QoS profile includes a response time requirement for providing positioning information within the positioning session; receive a second message via the transceiver from the second UE, wherein the second message comprises an indication of whether the second UE can meet the response time requirement; determine resource pool parameters for the positioning session, wherein the resource pool parameters are based at least in part on the indication of whether the second UE can meet the response time requirement; and send, via the transceiver to the second UE, a third message comprising the resource pool parameters.
Clause 22. The first UE of clause 21, wherein the one or more processors are configured to include, in the resource pool parameters: a dedicated positioning resource pool, a contention based pool, a sensing-window-positioning duration, a type of sensing, or a combination thereof.
Clause 23. The first UE of any one of clauses 21-22 wherein the one or more processors are configured to include, in the QoS profile: a horizontal accuracy requirement, a vertical accuracy requirement, a vertical coordinate request indicator, a velocity request indicator, or a combination thereof.
Clause 24. The first UE of any one of clauses 21-23 wherein the one or more processors are configured to determine a priority level for the positioning session, wherein the priority level is included in the resource pool parameters for the positioning session when the indication of whether the second UE can meet the response time requirement comprises an indication the second UE cannot meet the response time requirement.
Clause 25. The first UE of any one of clauses 21-24 wherein the one or more processors are configured to determine random selection sensing as a type of sensing for the positioning session when the indication of whether the second UE can meet the response time requirement comprises an indication the second UE cannot meet the response time requirement, and wherein the one or more processors are configured to include random selection sensing in the resource pool parameters for the positioning session.
Clause 26. A second user equipment (UE) for managing response time in a positioning session between a first UE and the second UE conducted via sidelink (SL), the second UE comprising: a transceiver; a memory; and one or more processors communicatively coupled with the transceiver and the memory, wherein the one or more processors are configured to: receive, via the transceiver from the first UE, a first message comprising a quality of service (QoS) profile, wherein the QoS profile includes a response time requirement for providing positioning information within the positioning session; send a second message via the transceiver to the first UE, wherein the second message comprises an indication of whether the second UE can meet the response time requirement; and receive, via the transceiver from the first UE, a third message comprising resource pool parameters for the positioning session, wherein the resource pool parameters are based at least in part on the indication of whether the second UE can meet the response time requirement.
Clause 27. The second UE of clause 26, wherein the one or more processors are further configured to determine, with the second UE, that the second UE cannot meet the response time requirement.
Clause 28. The second UE of any one of clauses 26-27 wherein the one or more processors are further configured to, responsive to determining the second UE cannot meet the response time requirement, determine a priority level for the positioning session.
Clause 29. The second UE of any one of clauses 26-28 wherein the one or more processors are further configured to, responsive to determining the second UE cannot meet the response time requirement, determine random selection sensing as a type of sensing for the positioning session.
Clause 30. The second UE of any one of clauses 26-29 wherein the one or more processors are further configured to, responsive to determining the second UE cannot meet the response time requirement, determine a physical (PHY) layer transmission parameter.
Clause 31. An apparatus having means for performing the method of any one of clauses 1-20.
Clause 32. A non-transitory computer-readable medium storing instructions, the instructions comprising code for performing the method of any one of clauses 1-20.

What is claimed is:

1. A method of managing response time in a positioning session between a first user equipment (UE) and a second UE conducted via sidelink (SL), the method comprising:
sending, from the first UE to the second UE, a first message comprising a quality of service (QoS) profile, wherein the QoS profile includes a response time requirement for providing positioning information within the positioning session;
receiving a second message at the first UE from the second UE, wherein the second message comprises an indication of whether the second UE can meet the response time requirement;
determining, with the first UE, resource pool parameters for the positioning session, wherein the resource pool parameters are based at least in part on the indication of whether the second UE can meet the response time requirement; and
sending, from the first UE to the second UE, a third message comprising the resource pool parameters.

2. The method of claim 1, wherein the resource pool parameters comprise:
a dedicated positioning resource pool,
a contention based pool,
a sensing-window-positioning duration,
a type of sensing, or
a combination thereof.

3. The method of claim 2, wherein the type of sensing comprises:
full sensing,
partial sensing, or
random selection sensing.

4. The method of claim 1, wherein the QoS profile further comprises:
a horizontal accuracy requirement,
a vertical accuracy requirement,
a vertical coordinate request indicator,
a velocity request indicator, or
a combination thereof.

5. The method of claim 1, wherein the indication of whether the second UE can meet the response time requirement comprises an indication the second UE cannot meet the response time requirement.

6. The method of claim 5, further comprising, responsive to the indication the second UE cannot meet the response time requirement, determining, with the first UE, a priority level for the positioning session, wherein the priority level is included in the resource pool parameters for the positioning session.

7. The method of claim 5, further comprising, responsive to the indication the second UE cannot meet the response time requirement, determining, with the first UE, random selection sensing as a type of sensing for the positioning session, wherein the random selection sensing is included in the resource pool parameters for the positioning session.

8. The method of claim 5, further comprising, responsive to the indication the second UE cannot meet the response time requirement, determining, with the first UE, a physical (PHY) layer transmission parameter, wherein the PHY layer transmission parameter is included in the resource pool parameters for the positioning session.

9. The method of claim 1, wherein:
the second message is received and the third message is sent prior to the positioning session; or
the second message is received and the third message is sent during to the positioning session.

10. The method of claim 1, wherein the positioning session uses a resource pool carrying SL positioning reference signal (SL-PRS), SL physical sidelink control channel (PSCCH), or both.

11. A method of managing response time in a positioning session between a first user equipment (UE) and a second UE conducted via sidelink (SL), the method comprising:
receiving, at the second UE from the first UE, a first message comprising a quality of service (QoS) profile, wherein the QoS profile includes a response time requirement for providing positioning information within the positioning session;
sending a second message from the second UE to the first UE, wherein the second message comprises an indication of whether the second UE can meet the response time requirement; and
receiving, at the second UE from the first UE, a third message comprising resource pool parameters for the positioning session, wherein the resource pool parameters are based at least in part on the indication of whether the second UE can meet the response time requirement.

12. The method of claim 11, wherein the resource pool parameters comprise:
a dedicated positioning resource pool,
a contention based pool,
a sensing-window-positioning duration,
a type of sensing, or
a combination thereof.

13. The method of claim 12, wherein the type of sensing comprises:
full sensing,
partial sensing, or
random selection sensing.

14. The method of claim 11, wherein the QoS profile further comprises:
a horizontal accuracy requirement,
a vertical accuracy requirement,
a vertical coordinate request indicator,
a velocity request indicator, or
a combination thereof.

15. The method of claim 11, further comprising determining, with the second UE, that the second UE cannot meet the response time requirement.

16. The method of claim 15, further comprising, responsive to determining the second UE cannot meet the response time requirement, determining, with the second UE, a priority level for the positioning session.

17. The method of claim 15, further comprising, responsive to determining the second UE cannot meet the response time requirement, determining, with the second UE, random selection sensing as a type of sensing for the positioning session.

18. The method of claim 15, further comprising, responsive to determining the second UE cannot meet the response time requirement, determining, with the second UE, a physical (PHY) layer transmission parameter.

19. The method of claim 11, wherein:
the second message is sent and the third message is received to the positioning session; or
the second message is sent and the third message is received during to the positioning session.

20. The method of claim 11, wherein the positioning session uses a resource pool carrying SL positioning reference signal (SL-PRS), SL physical sidelink control channel (PSCCH), or both.

21. A first user equipment UE for managing response time in a positioning session between the first UE and a second UE conducted via sidelink (SL), the first UE comprising:
a transceiver;
a memory; and
one or more processors communicatively coupled with the transceiver and the memory, wherein the one or more processors are configured to:
send, via the transceiver to the second UE, a first message comprising a quality of service (QoS) profile, wherein the QoS profile includes a response time requirement for providing positioning information within the positioning session;
receive a second message via the transceiver from the second UE, wherein the second message comprises an indication of whether the second UE can meet the response time requirement;
determine resource pool parameters for the positioning session, wherein the resource pool parameters are based at least in part on the indication of whether the second UE can meet the response time requirement; and
send, via the transceiver to the second UE, a third message comprising the resource pool parameters.

22. The first UE of claim 21, wherein the one or more processors are configured to include, in the resource pool parameters:
a dedicated positioning resource pool,
a contention based pool,
a sensing-window-positioning duration,
a type of sensing, or
a combination thereof.

23. The first UE of claim 21, wherein the one or more processors are configured to include, in the QoS profile:
a horizontal accuracy requirement,
a vertical accuracy requirement,
a vertical coordinate request indicator,
a velocity request indicator, or
a combination thereof.

24. The first UE of claim 21, wherein the one or more processors are configured to determine a priority level for the positioning session, wherein the priority level is included in the resource pool parameters for the positioning session when the indication of whether the second UE can meet the response time requirement comprises an indication the second UE cannot meet the response time requirement.

25. The first UE of claim 24, wherein the one or more processors are configured to determine random selection sensing as a type of sensing for the positioning session when the indication of whether the second UE can meet the response time requirement comprises an indication the second UE cannot meet the response time requirement, and wherein the one or more processors are configured to include random selection sensing in the resource pool parameters for the positioning session.

26. A second user equipment (UE) for managing response time in a positioning session between a first UE and the second UE conducted via sidelink (SL), the second UE comprising:
a transceiver;
a memory; and
one or more processors communicatively coupled with the transceiver and the memory, wherein the one or more processors are configured to:
receive, via the transceiver from the first UE, a first message comprising a quality of service (QoS) profile, wherein the QoS profile includes a response time requirement for providing positioning information within the positioning session;
send a second message via the transceiver to the first UE, wherein the second message comprises an indication of whether the second UE can meet the response time requirement; and
receive, via the transceiver from the first UE, a third message comprising resource pool parameters for the positioning session, wherein the resource pool parameters are based at least in part on the indication of whether the second UE can meet the response time requirement.

27. The second UE of claim 26, wherein the one or more processors are further configured to determine, with the second UE, that the second UE cannot meet the response time requirement.

28. The second UE of claim 27, wherein the one or more processors are further configured to, responsive to determining the second UE cannot meet the response time requirement, determine a priority level for the positioning session.

29. The second UE of claim 27, wherein the one or more processors are further configured to, responsive to determining the second UE cannot meet the response time requirement, determine random selection sensing as a type of sensing for the positioning session.

30. The second UE of claim 27, wherein the one or more processors are further configured to, responsive to determining the second UE cannot meet the response time requirement, determine a physical (PHY) layer transmission parameter.
